(19) United States
(12) Patent Application Publication
(10) Pub. No.: US 2024/0206024 A1
(43) Pub. Date: Jun. 20, 2024

(54) Cooking Vessel, Cooking System, and Method

(71) Applicant: Vestel Elektronik Sanayi ve Ticaret A.S., Manisa (TR)

(72) Inventors: Mert Kahyaoglu, Manisa (TR); Nevzat Yalin, Manisa (TR)

(21) Appl. No.: 18/555,296

(22) PCT Filed: Apr. 28, 2021
(86) PCT No.: PCT/EP2021/061111

§ 371 Date: Oct. 13, 2023

(30) Foreign Application Priority Data
Apr. 16, 2021 (EP) 21168890.8

(51) Int. Cl. H05B 6/12

(52) U.S. Cl. CPC H05B 6/1236

(57) ABSTRACT

The present disclosure provides a cooking vessel stirring device for stirring contents of a cooking vessel, including a mechanical fixation element configured to fix the cooking vessel stirring device in the cooking vessel, an inductive energy harvesting circuit configured to generate electrical energy from an external magnetic field, and an electric engine mechanically coupled to the mechanical fixation element and electrically coupled to the inductive energy harvesting circuit. The electric engine is configured operate based on electrical energy provided by the inductive energy harvesting circuit. Further, the present disclosure provides a cooking system and a respective method.

### CROSS REFERENCE TO RELATED APPLICATIONS

This application is a U.S. national phase of International Application No. PCT/EP2021/061111, filed Apr. 28, 2021, which claims priority to European Application No. 21168890.8, filed Apr. 16, 2021, both of which are incorporated by reference herein in their entirety.

### FIELD OF THE DISCLOSURE

The disclosure relates to a cooking vessel, a cooking system, and a respective method.

### BACKGROUND

Although applicable to any cooking device, the present disclosure will mainly be described in conjunction with inductive cooking hobs.

When cooking with induction stoves or hobs, solid materials in the cooking vessel usually sink to the bottom of the cooking vessel, if the solid materials are not mixed during cooking.

However, some foods need to be mixed during cooking e.g., for preventing the foods from burning or for ensuring homogenous cooking and distribution of spices or the like. Usually the user that uses the cooking hob will manually stir the foods during the cooking process e.g., with a cooking spoon.

Accordingly, there is a need for improving the cooking process for users.

### SUMMARY

The above stated problem is solved by the features of the independent claims. It is understood, that independent claims of a claim category may be formed in analogy to the dependent claims of another claim category.

Accordingly, it is provided:

A cooking vessel stirring device for stirring contents of a cooking vessel, comprising a mechanical fixation element configured to fix the cooking vessel stirring device in the cooking vessel, an inductive energy harvesting circuit configured to generate electrical energy from an external magnetic field, and an electric engine mechanically coupled to the mechanical fixation element and electrically coupled to the inductive energy harvesting circuit, wherein the electric engine is configured to operate based on electrical energy provided by the inductive energy harvesting circuit.

Further, it is provided:

A cooking system comprising a cooking vessel, a number i.e., one or more, of cooking vessel stirring device according to the present disclosure arranged in the cooking vessel, and an inductive cooking hob with at least one inductive cooking zone configured to accept the cooking vessel.

Further, it is provided:

A method for stirring contents of a cooking vessel in a cooking system according the present disclosure, the method comprising mechanically fixing the cooking vessel stirring device in the cooking vessel, generating a magnetic field with a predefined frequency in the cooking zone of the cooking hob which carries the cooking vessel, harvesting electrical energy from the generated magnetic field in the cooking vessel stirring device, and operating the electric engine of the cooking vessel stirring device based on the harvested electrical energy.

The present disclosure is based on the finding that present solutions for improving the cooking process, like e.g. mixers with integrated heating, usually limit the cook in the cooking process. Mixers for example usually comprise a limited capacity in the cooking vessel.

The present disclosure therefore provides the possibility to use conventional cooking vessels, like pots, and add an automatic stirring to the cooking vessels.

To this end, the present disclosure provides the cooking vessel stirring device, that may be inserted into a cooking vessel for automatic stirring of the contents of the cooking vessel.

The cooking vessel stirring device to this end comprises the mechanical fixation element. With the mechanical fixation element, the cooking vessel stirring device may be fixed in the cooking vessel at a specific position. The cooking vessel stirring device may therefore be held in a specific place in the cooking vessel, especially but not necessarily on the bottom of the cooking vessel.

Coupled to the mechanical fixation element an electric engine is provided. The electric engine is electrically coupled to an inductive energy harvesting circuit and is mechanically coupled to the mechanical fixation element.

The cooking vessel stirring device may therefore be fixed on the bottom of a cooking vessel and may receive electrical energy from the inductive energy harvesting circuit. The electric engine may operate based on the electrical energy received from the inductive energy harvesting circuit.

The cooking vessel stirring device may for example be used with a cooking system according to the present disclosure. Such a cooking system comprises an inductive cooking hob with at least one inductive cooking zone that generates a magnetic field to heat up a cooking vessel. In combination with such an inductive cooking hob, the cooking vessel stirring device is powered by the magnetic field generated by the inductive cooking hob for heating up the cooking vessel.

During a cooking operation, the contents in a cooking vessel may therefore be stirred automatically and without limiting the user to a specific cooking device, like a mixer with included heating function.

Further embodiments of the present disclosure are subject of the further subclaims and of the following description, referring to the drawings.

In an embodiment, the inductive energy harvesting circuit may comprise an induction coil coupled to a rectifier circuit, wherein the rectifier circuit may be configured to output electrical energy.

As explained above, the inductive energy harvesting circuit harvests electrical energy from a magnetic field. Using an induction coil together with a rectifier circuit allows easily harvesting electrical energy with a circuit of low complexity.

In other embodiments, the inductive energy harvesting circuit only comprises an induction coil that outputs alternating voltage and current and directly drives the electrical engine. It is understood, that the term “directly” in this context also allows including any supporting circuitry that is required to drive the electric engine with the alternating voltage and current, like e.g. capacitors, resistors or the like. The term “directly” in this context does however, not encompass the use of active engine control elements, like a switches and the like.

In another embodiment, the inductive energy harvesting circuit may be tuned to harvest electrical energy from a magnetic field with a predetermined frequency.

The inductive energy harvesting circuit may be tuned to operate at specific frequencies. The inductive energy harvesting circuit may for example be tuned to operate at a frequency that is used by the inductive cooking hob of the cooking system to drive the induction coils in the cooking zones.

The frequency that is used by the inductive cooking hob may be detected by an analog-to-digital conversion circuit in the inductive energy harvesting circuit. A controller in the inductive energy harvesting circuit may then determine the frequency and for example actively control switches in a the inductive energy harvesting circuit accordingly, such the amount of harvested energy is maximized.

It is further understood, that in a cooking system with multiple cooking vessel stirring devices, the single cooking vessel stirring devices may be tuned to operate at different frequencies, i.e. the inductive energy harvesting circuits may be adapted respectively.

For example, a first cooking vessel stirring device may be tuned to operate at 1 KHz, a second cooking vessel stirring device may be tuned to operate at 1.5 kHz, and so on.

In case a direct supply of the electric engine, i.e. without active control elements, is used, the electric engine may rotate with a frequency that is directly proportional to the frequency of the magnetic field and the number of poles of the electric engine. The electric engine may in such embodiments for example be provided as asynchronous engine or motor.

In an alternative embodiment, all cooking vessel stirring devices may be tuned to operate at the same frequency. However, controllers in the cooking vessel stirring devices may be configured to drive the respective electric engine at different speeds.

In a further embodiment, the cooking vessel stirring device may comprise an engine controller coupled electrically between the inductive energy harvesting circuit and the electric engine. The engine controller may be configured to control the electric engine based on the electrical energy provided by the inductive energy harvesting circuit.

The engine controller may be any device that is capable of controlling the electrical engine. Therefore, the engine controller may be adapted to the type of electric engine used. If for example, the electric engine is an asynchronous engine, the engine controller may be a kind of variable frequency drive (VFD) controller.

In case that the electric engine is a constant current engine, the engine controller may comprise e.g. a simple switch or a voltage controller to provide the engine with a predetermined input voltage from the inductive energy harvesting circuit. If the engine is to run in two directions, the engine controller may comprise an H-bridge circuit.

In another embodiment, the engine controller may comprise a control interface configured to receive control signals, and wherein the engine controller may be configured to control the electric engine based on the control signals.

The control interface may be provided as wireless control interface. In an embodiment, the control interface is provided as a function in the engine controller that determines the frequency of the magnetic field that provides power to the inductive energy harvesting circuit. For example, a first frequency may be defined that indicates that the electric engine is not to run, a second frequency may indicated that the electric engine is to run. In an embodiment, two different frequencies may be defined to indicate in which direction the electric engine is to run.

In another embodiment, the magnetic field created to heat up the cooking vessel may be modulated based on control information. The communication interface may be configured to demodulate the received signal to reconstruct the control information.

In another embodiment, the control interface may comprise any type of wireless interface that allows transmitting the required information to the engine controller, such a wireless interface may comprise e.g., RFID or NFC type interfaces, Bluetooth interfaces or the like.

In an embodiment, the mechanical fixation element may comprises a suction cup or suction pad configured to fix the cooking vessel stirring device.

The suction cup provides a very flexible mechanical arrangement that serves for fixing the cooking vessel stirring device on different surfaces, especially on the bottom surface or the inner side of the wall of a cooking vessel.

With a mechanical fixation element that comprises a suction cup, the cooking vessel stirring device may be used with any type of cooking vessel without the need to provide specific holding elements in the cooking vessel.

In another embodiment, the mechanical fixation element comprises a bayonet coupling or a screw coupling or a snap-on element.

In contrast to the suction cup fixation, the bayonet coupling, the screw coupling and the snap-on element may be used with cooking vessels that provide respective counterparts.

While the bayonet coupling of the cooking vessel stirring device may comprise a rod-type element, the cooking vessel may comprise a respective recess for inserting the rod-type element. With a screw coupling, the cooking vessel stirring device may be provided with a screw, while the cooking vessel may be provided with respective threaded holes for inserting the screw. If a snap-on element is used with the cooking vessel stirring device, the cooking vessel may be equipped with respective counterparts for the snap-on element.

With such mechanical fixation elements, the cooking vessel stirring device may be fixed strongly to the cooking vessel and may therefore provide high stirring forces.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 shows a block diagram of an embodiment of a cooking vessel stirring device according to the present disclosure;

FIG. 2 shows a block diagram of another embodiment of a cooking vessel stirring device according to the present disclosure;

FIG. 3 shows a block diagram of an embodiment of a cooking system according to the present disclosure; and

FIG. 4 shows a flow diagram of an embodiment of a method according to the present disclosure.

In the figures like reference signs denote like elements unless stated otherwise.

### DETAILED DESCRIPTION

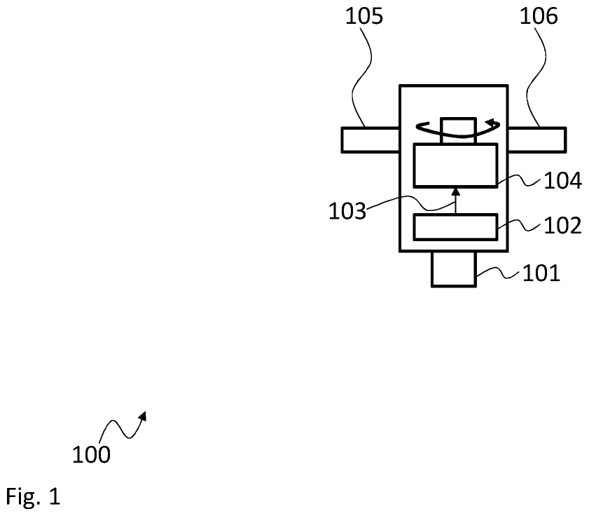

FIG. 1 shows a block diagram of a cooking vessel stirring device 100. The cooking vessel stirring device 100 comprises a mechanical fixation element 101, an inductive energy harvesting circuit 102, and an electric engine 104.

The mechanical fixation element 101 serves for fixing the cooking vessel stirring device 100 in the cooking vessel. Although not explicitly shown, it is understood, that the mechanical fixation element 101 may be mechanically coupled to a static element of the cooking vessel stirring device 100, like e.g. a housing-part.

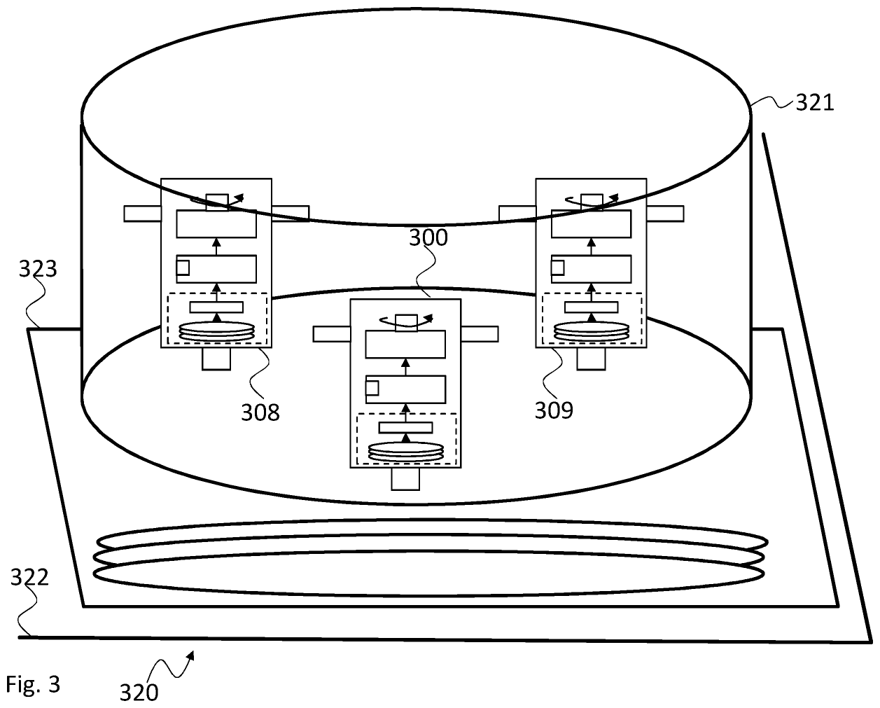

The inductive energy harvesting circuit 102 generates electrical energy 103 from an external magnetic field that may be provided to the cooking vessel stirring device 100 e.g., from an inductive cooking zone as shown in FIG. 3. It is however understood, that the source of the magnetic field may also be another source than an inductive cooking zone. For example, conventional cooking hobs or gas cooking hobs may be equipped with an additional magnetic field source. This allows using the cooking vessel stirring device 100 with any type of cooking hob.

The inductive energy harvesting circuit 102 is electrically coupled to the electric engine 104. Further, the static section of the electric engine 104 is mechanically coupled to the mechanical fixation element 101, e.g. via the above-mentioned housing part.

A rotor of the electric engine 104 is coupled to another part of the housing e.g., to a rotating part of the housing. In embodiments, the rotating part of the housing and the rotor of the electric engine 104 are the same part. In the cooking vessel stirring device 100 stirring blades 105, 106 are attached on the outside of the rotating part of the cooking vessel stirring device 100 e.g. to the rotor of the electric engine 104.

The mechanical fixation element 101 may e.g. be provided as a suction cup that may be fixed to the bottom or the side walls of the cooking vessel stirring device 100. It is understood, that the mechanical fixation element 101 may also comprise a bayonet coupling or a screw coupling or a snap-on element or any other mechanically releasable fixing mechanism with interlocking parts.

In an embodiment, the mechanical fixation element 101 may comprise a fixation base for fixation on a surface and a rod that stands up and forms an internal stator for the electric engine 104. The rod may comprise respective permanent magnets. The further elements of the cooking vessel stirring device 100 may then be provided in a housing that comprises a round recess and may be put on said rod.

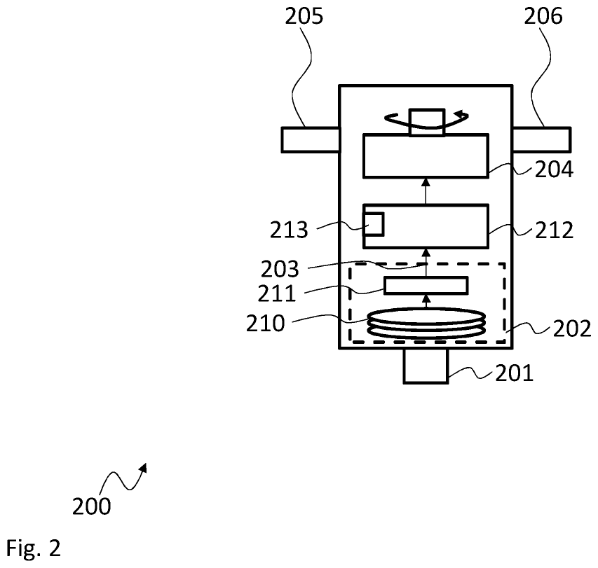

FIG. 2 shows a block diagram of another cooking vessel stirring device 200. The cooking vessel stirring device 200 is based on the cooking vessel stirring device 100. Therefore, the cooking vessel stirring device 200 comprises a mechanical fixation element 201, an inductive energy harvesting circuit 202, and an electric engine 204.

The inductive energy harvesting circuit 202 of the cooking vessel stirring device 200 comprises an induction coil 210 coupled to a rectifier circuit 211. In the inductive energy harvesting circuit 202, the induction coil 210 is excited by an external magnetic field to output respective electrical energy. The rectifier circuit 211 receives the output provided by the induction coil 210, rectifies the received electrical energy i.e., the voltage and current, for example with respective diodes, and outputs the electrical energy 203 to an engine controller 212 that is coupled electrically between the inductive energy harvesting circuit 202 and the electric engine 204.

The inductive energy harvesting circuit 202 may be tuned to harvest electrical energy 203 from a magnetic field with a predetermined frequency. To this end, the induction coil 210 may be dimensioned accordingly and the rectifier circuit 211 may comprise respective elements or a respective circuit may be provided tuned to said frequency.

The engine controller 212 is configured to control the electric engine 204 based on the electrical energy 203 provided by the inductive energy harvesting circuit 202.

In the cooking vessel stirring device 200, the engine controller 212 comprises a control interface 213. The control interface 213 may serve for providing control information wirelessly to the engine controller 212.

The control interface 213 may for example be implemented by a demodulator that demodulates the control information in the signal provided from the induction coil 210 to the engine controller 212. The source of the magnetic field may comprise a respective counterpart that modulates the control information into the magnetic field. The modulation may e.g. be a frequency modulation or a kind of PWM-based modulation or the like.

In the engine controller 212 the control information may be used to control the electric engine 204 accordingly. For example, the control information may indicate to the engine controller 212 that the electric engine 204 is to be activated i.e., operated to run in a specific direction, or to be stopped.

It is understood, that the engine controller 212 is optional. In an embodiment, the electric engine 204 may be driven directly with the output of the induction coil 210. Further, if the engine controller 212 is provided the control interface 213 is optional. Without the control interface 213 the engine controller 212 may be configured to directly operate the electric engine 204 as soon as output is provided by the induction coil 210.

FIG. 3 shows a block diagram of an embodiment of a cooking system 320. The cooking system 320 comprises a cooking vessel 321 that is arranged on an inductive cooking zone 323 of an inductive cooking hob 322 (only schematically shown).

The inductive cooking hob 322 may comprise any number of inductive cooking zones, although only one cooking zone 323 is shown in FIG. 3. Further, flexible cooking zones may be provided i.e., no specific location is defined for a cooking zone. Instead, a controller of the inductive cooking hob 322 may detect where on the surface of the inductive cooking hob 322 the cooking vessel 321 is placed and activate a respective coil or respective coils.

The cooking vessel 321 as shown in FIG. 3 is provided with three cooking vessel stirring devices 300, 308, 309. It is understood that any other number of cooking vessel stirring devices is possible. The cooking vessel stirring devices 300, 308, 309 are cooking vessel stirring devices as shown in FIG. 2. It is understood, that any other embodiment of a cooking vessel stirring device as shown in the present disclosure may be used.

If cooking vessel stirring devices 300, 308, 309 with an engine controller and a control interface are provided, a controller in the inductive cooking hob 322 may modulate the magnetic field generated by the induction coil of the inductive cooking zone 323 accordingly. The inductive cooking hob 322 may also comprise respective controls that allow a user to control the operation of the cooking vessel stirring devices 300, 308, 309. In addition, or as alternative, the control interface may be a communication interface that may communicate with mobile devices, like e.g. a smartphone. Such a control interface may be e.g., a WiFi or Bluetooth interface.

A user may then be provided with a respective application on the mobile device to control the cooking vessel stirring devices 300, 308, 309.

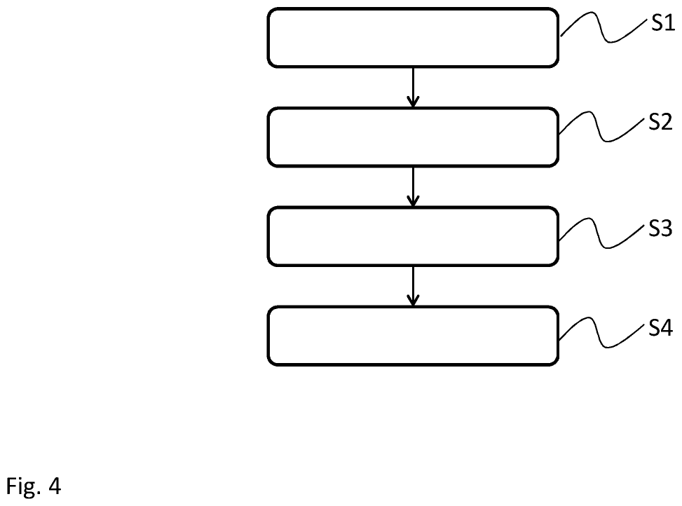

For sake of clarity in the following description of the method based FIG. 4 the reference signs used above in the description of apparatus based FIGS. 1-3 will be maintained.

FIG. 4 shows a flow diagram of a method for stirring contents of a cooking vessel 321 in a cooking system 320 according to the present disclosure.

The method comprises mechanically fixing S1 the cooking vessel stirring device 100, 200, 300, 308, 309 in the cooking vessel 321, generating S2 a magnetic field with a predefined frequency in the cooking zone of the cooking hob which carries the cooking vessel 321, harvesting S3 electrical energy 103, 203 from the generated magnetic field in the cooking vessel stirring device 100, 200, 300, 308, 309, and operating S4 the electric engine 104, 204 of the cooking vessel stirring device 100, 200, 300, 308, 309 based on the harvested electrical energy.

The electrical energy 103, 203 may be harvested via an induction coil 210 coupled to a rectifier circuit 211 that outputs the electrical energy 103, 203. In embodiments, the electrical energy 103, 203 may be harvested from a magnetic field with a predetermined frequency.

The method may also comprise controlling the electric engine 104, 204 of the cooking vessel stirring device 100, 200, 300, 308, 309 based on the harvested electrical energy 103, 203. Therein, controlling may comprise receiving control signals in the cooking vessel stirring device 100, 200, 300, 308, 309, and controlling the electric engine 104, 204 based on the control signals.

Mechanically fixing may comprise fixing the cooking vessel stirring device 100, 200, 300, 308, 309 in the cooking vessel 321 with a suction cup. As alternative, mechanically fixing may comprise fixing the cooking vessel stirring device 100, 200, 300, 308, 309 in the cooking vessel 321 with a bayonet coupling or a screw coupling or a snap-on element.

Although specific embodiments have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

List of reference signs

| | |
|---|---|
| 100, 200, 300, 308, 309 | cooking vessel stirring device |
| 101, 201 | mechanical fixation element |
| 102, 202 | inductive energy harvesting circuit |
| 103, 203 | electrical energy |
| 104, 204 | electric engine |
| 105, 106, 205, 206 | stirring blade |
| 210 | induction coil |
| 211 | rectifier circuit |
| 212 | engine controller |
| 213 | control interface |
| 320 | cooking system |
| 321 | cooking vessel |
| 322 | inductive cooking hob |
| 323 | inductive cooking zone |
| S1-S4 | method steps |

1. A cooking vessel stirring device for stirring contents of a cooking vessel, comprising:
a mechanical fixation element configured to fix the cooking vessel stirring device in the cooking vessel;
an inductive energy harvesting circuit configured to generate electrical energy from an external magnetic field; and
an electric engine mechanically coupled to the mechanical fixation element and electrically coupled to the inductive energy harvesting circuit, wherein the electric engine is configured to operate based on electrical energy provided by the inductive energy harvesting circuit.

2. The cooking vessel stirring device according to claim 1, wherein the inductive energy harvesting circuit comprises an induction coil coupled to a rectifier circuit, wherein the rectifier circuit is configured to output electrical energy.

3. The cooking vessel stirring device according to claim 1, wherein the inductive energy harvesting circuit is tuned to harvest electrical energy from a magnetic field with a predetermined frequency.

4. The cooking vessel stirring device according to claim 1, comprising an engine controller coupled electrically between the inductive energy harvesting circuit and the electric engine, wherein the engine controller is configured to control the electric engine based on the electrical energy provided by the inductive energy harvesting circuit.

5. The cooking vessel stirring device according to claim 4, wherein the engine controller comprises a control interface configured to receive control signals, and wherein the engine controller is configured to control the electric engine based on the control signals.

6. The cooking vessel stirring device according to claim 1, wherein the mechanical fixation element comprises a suction cup configured to fix the cooking vessel stirring device.

7. The cooking vessel stirring device according to claim 1, wherein the mechanical fixation element comprises a bayonet coupling or a screw coupling or a snap-on element.

8. A cooking system comprising
a cooking vessel;
a number of cooking vessel stirring devices according to claim 1 arranged in the cooking vessel; and
an inductive cooking hob with at least one inductive cooking zone configured to accept the cooking vessel.

9. The method for stirring contents of a cooking vessel in a cooking system according to claim 8, comprising:
mechanically fixing the cooking vessel stirring device in the cooking vessel;
generating a magnetic field with a predefined frequency in the cooking zone of the cooking hob which carries the cooking vessel;
harvesting electrical energy from the generated magnetic field in the cooking vessel stirring device; and
operating the electric engine of the cooking vessel stirring device based on the harvested electrical energy.

10. The method according to claim 9, wherein the electrical energy is harvested via an induction coil coupled to a rectifier circuit that outputs the electrical energy.

11. The method according to claim 9, wherein electrical energy is harvested from a magnetic field with a predetermined frequency.

12. The method according to claim 9, comprising controlling the electric engine of the cooking vessel stirring device based on the harvested electrical energy.

13. The method according to any claim 12, wherein controlling comprises receiving control signals in the cooking vessel stirring device, and controlling the electric engine based on the control signals.

14. The method according to claim 9, wherein mechanically fixing comprises fixing the cooking vessel stirring device in the cooking vessel with a suction cup.

15. The method according to claim 9, wherein mechanically fixing comprises fixing the cooking vessel stirring device in the cooking vessel with a bayonet coupling or a screw coupling or a snap-on element.
